(19) United States
(12) Patent Application Publication
(10) Pub. No.: US 2024/0163060 A1
(43) Pub. Date: May 16, 2024

(54) TERMINAL, RADIO COMMUNICATION SYSTEM AND RADIO COMMUNICATION METHOD

(71) Applicant: NTT DOCOMO, INC., Tokyo (JP)

(72) Inventors: Yuki Matsumura, Tokyo (JP); Shohei Yoshioka, Tokyo (JP); Satoshi Nagata, Tokyo (JP)

(73) Assignee: NTT DOCOMO, INC., Tokyo (JP)

(21) Appl. No.: 18/282,714

(22) PCT Filed: Mar. 19, 2021
(86) PCT No.: PCT/JP2021/011517

§ 371 Date: Sep. 18, 2023

(51) Int. Cl. H04L 5/00

(52) U.S. Cl. CPC H04L 5/0053

(57) ABSTRACT

A terminal receives a downlink data channel common to a group of terminals in data distribution for a plurality of terminals. The terminal assumes that the quasi collocation of the downlink data channel is a specific state common to a plurality of terminals when a specific condition is satisfied.

### TECHNICAL FIELD

The present disclosure relates to a terminal, a radio communication system and a radio communication method corresponding to a multicast/broadcast service.

### BACKGROUND ART

3rd Generation Partnership Project (3GPP) specifies 5th generation mobile communication system (5G, also called New Radio (NR) or Next Generation (NG), further, a succeeding system called Beyond 5G, 5G Evolution or 6G is being specified.

Release 17 of the 3GPP covers simultaneous data transmission (also called broadcasting) services (tentatively called Multicast and Broadcast Services (MBS)) to specified or unspecified multiple terminals (User Equipment, UE) in NR (Non-Patent Literature 1).

Release-16 of 3GPP also specifies that, for Quasi-Colocation (QCL), if the time between the receipt of Downlink Control Information (DCI) and the Physical Downlink Shared Channel (PDSCH) is shorter than the specified time (timeDurationForQCL), the QCL with the lowest control resource sets (CORESET) ID of the latest monitoring slot is used to receive the PDSCH (Non-Patent Literature 2).

### CITATION LIST

### Non-Patent Literature

[Non-Patent Literature 1]
“New Work Item on NR support of Multicast and Broadcast Services,” RP-193248, 3GPP TSG RAN Meeting #86, 3GPP, December 2019
[Non-Patent Literature 2]
3GPP TS 38.214 V 16.4.0, 3rd Generation Partnership Project; Technical Specification Group Radio Access Network; NR; Physical layer procedures for data (Release 16), 3GPP, December 2020

### SUMMARY OF INVENTION

The QCL with the minimum CORESET ID for the latest monitoring slot is different for each UE and may be a unicast CORESET. Therefore, the QCL of the appropriate multicast PDSCH (which may be called group-common PDSCH) cannot be determined even if the above operation is applied to the MBS.

Therefore, the following disclosure is made in view of this situation, and is intended to provide a terminal, a radio communication system, and a radio communication method that can assume appropriate quasi collocation in a simultaneous data transmission service to a plurality of specified or unspecified terminals.

An aspect of the present disclosure is a terminal (UE200) including a reception unit (radio signal transmission and reception unit 210) that receives a downlink data channel common to a group of terminals in data distribution for a plurality of terminals and a control unit (control unit 270) that assumes that quasi collocation of the downlink data channel is a specific state common to the plurality of terminals when a specific condition is satisfied.

An aspect of the present disclosure is radio communication system including a radio base station and a terminal. The radio base station includes a transmission unit that transmits a downlink data channel common to a group of terminals in data distribution for a plurality of terminals, and the terminal includes a reception unit that receives the downlink data channel and a control unit that assumes that quasi collocation of the downlink data channel is a specific state common to the plurality of terminals when a specific condition is satisfied.

An aspect of the present disclosure is radio communication method comprising the steps of receiving a downlink data channel common to a group of terminals in data distribution for a plurality of terminals and assuming that quasi collocation of the downlink data channel is in a specific state common to the plurality of terminals when a specific condition is satisfied.

### BRIEF DESCRIPTION OF DRAWINGS

FIG. 1 is a general schematic diagram of a radio communication system 10.

FIG. 2 is a diagram showing a configuration example of a radio frame, a sub-frame and a slot used in radio communication system 10.

FIG. 3 is a diagram showing an example of configuring the TCI state field of DCI format 1_1/1_2.

FIG. 4 is a diagram showing an example (No. 1) of the relationship between DCI format 1_0, timeDurationForQCL and PDSCH.

FIG. 5 is a diagram showing a configuration example of the PTM transmission system 1 and the PTM transmission system 2.

FIG. 6 is a functional block diagram of the gNB100 and the UE200.

FIG. 7 is a diagram showing an example sequence of PDCCH, PDSCH and HARQ feedback in MBS.

FIG. 8 is a diagram showing an example (No. 2) of the relationship between DCI format 1_0, timeDurationForQCL and PDSCH.

FIG. 9 is a diagram showing an example of the relationship between group-common PDCCH, timeDurationForQCL and group-common PDSCH.

FIG. 10 is a diagram showing an example of the relationship between CFR, group-common PDCCH, group-common PDSCH and unicast PDCCH/PDSCH.

FIG. 11 is a diagram showing an example of a minimum DCI codepoint according to operation example 2.

FIG. 12 is a diagram showing an example of the relationship between CFR, group-common PDCCH, group-common PDSCH and unicast PDCCH/PDSCH according to the modified example.

FIG. 13 is a diagram showing an example of a hardware configuration of the gNB100 and the UE200.

### MODES FOR CARRYING OUT THE INVENTION

Exemplary embodiments of the present invention are explained below with reference to the accompanying drawings. Note that, the same or similar reference numerals have been attached to the same functions and configurations, and the description thereof is appropriately omitted.

### (1) Overall Schematic Configuration of the Radio Communication System

### (1.1) System Configuration Example

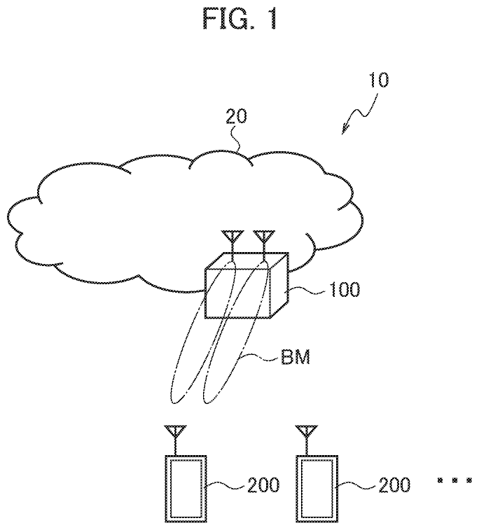

FIG. 1 is an overall schematic configuration diagram of a radio communication system 10 according to the present embodiment. The radio communication system 10 is a radio communication system according to 5G New Radio (NR) and includes the Next Generation-Radio Access Network 20 (hereinafter referred to as the NG-RAN20 and a plurality of terminals 200 (User Equipment 200, UE200).

The radio communication system 10 may be an radio communication system according to a system called Beyond 5G, 5G Evolution or 6G.

The NG-RAN20 includes a radio base station 100 (gNB100). The specific configuration of radio communication system 10 including the number of gNBs and UEs is not limited to the example shown in FIG. 1.

The NG-RAN20 actually includes a plurality of NG-RAN Nodes, specifically gNBs (or ng-eNBs), connected to a core network (5GC, not shown) according to 5G. Note that the NG-RAN20 and 5 GCs may be simply described as “networks”.

The gNB100 is a radio base station according to the NR, and performs radio communication according to the UE200 and the NR. The gNB100 and the UE200 can support Massive MIMO, which generates a more directional beam BM by controlling radio signals transmitted from a plurality of antenna elements, carrier aggregation (CA), which uses a plurality of component carriers (CCs) bundled together, and dual connectivity (DC), which simultaneously communicates between the UE and each of a plurality of NG-RAN nodes.

The radio communication system 10 corresponds to FR1 and FR2. The frequency band of each FR (Frequency Range) is as follows.
FR1:410 MHz-7.125 GHz
FR2:24.25 GHz-52.6 GHz

FR1 uses sub-carrier spacing (SCS) of 15, 30 or 60 kHz and may use a bandwidth (BW) of 5-100 MHz. FR2 is higher frequency than FR1 and may use SCS of 60 or 120 kHz (may include 240 kHz) and may use a bandwidth (BW) of 50400 MHz.

In addition, the radio communication system 10 may support higher frequency bands than those of FR2. Specifically, the radio communication system 10 may accommodate a frequency band greater than 52.6 GHz and up to 114.25 GHz. The radio communication system 10 may also accommodate a frequency band between FR1 and FR2.

Cyclic Prefix-Orthogonal Frequency Division Multiplexing (CP-OFDM)/Discrete Fourier Transform-Spread (DFT-S-OFDM) with greater Sub-Carrier Spacing (SCS) may also be applied. Furthermore, DFT-S-OFDM may be applied not only to the uplink (UL) but also to the downlink (DL).

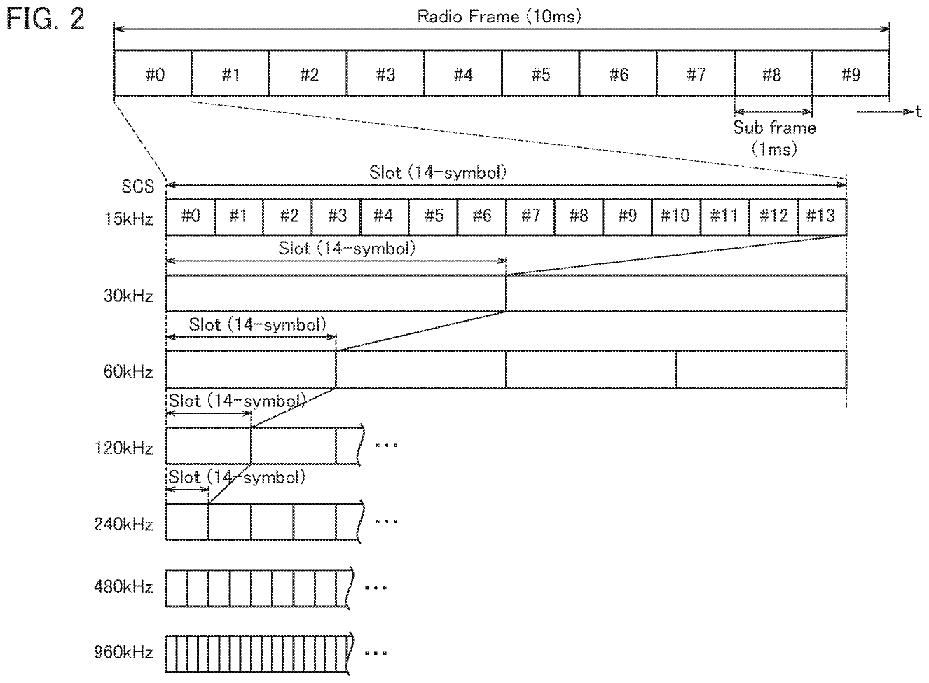

FIG. 2 shows a configuration example of a radio frame, subframe and slot used in radio communication system 10.

As shown in FIG. 2, one slot is composed of 14 symbols, and the larger (wider) the SCS, the shorter the symbol period (and slot period). Note that the number of symbols constituting one slot may not necessarily be 14 symbols (For example, 28, 56 symbols). The number of slots per subframe may vary depending on the SCS. In addition, the SCS may be wider than 240 kHz (For example, as shown in FIG. 2, 480 kHz, 960 kHz).

Note that the time direction (t) shown in FIG. 2 may be referred to as a time domain, symbol period, symbol time, etc. The frequency direction may be referred to as a frequency domain, resource block, resource block group, subcarrier, BWP (Bandwidth part), subchannel, common frequency resource, etc.

### (1.2) QCL/TCI State

Quasi-colocation (QCL) means that, for example, if the characteristics of the channel through which symbols are carried on one antenna port can be inferred from the channel through which symbols are carried on the other antenna port, the two antenna ports are located in the same pseudo location.

It can be interpreted that the QCL is assumed between SSBs with the same SSB index (Synchronization Signal/Physical Broadcast Channel blocks), and the QCL should not be assumed between other SSBs (i.e., different SSB indices). The QCL may be called quasi-collocation.

In order to receive the PDSCH (Physical Downlink Shared Channel) or PDCCH (Physical Downlink Control Channel) demodulation reference signal (DMRS), the TCI (Transmission Configuration Indication) state is set in the NR (If not set, it can be a QCL relationship with the SSB index of recent PRACH (Physical Random Access Channel) transmissions).

The TCI state may mean that it is explicitly set and instructed by a control element (MAC CE) of the radio resource control layer (RRC) or the medium access control layer (MAC). The QCL relationship may include both cases where the TCI state is explicitly set and cases where the TCI state is not set. The QCL/TCI state/Beam may be interchanged.

For example, if the Physical Downlink Control Channel (PDCCH) is pseudo-collocated with the SSB (QCLed), it can be interpreted that the PDCCH has passed through a channel state similar to the SSB (channel state, channel condition). Therefore, the channel estimation information for detecting the SSB is also useful for detecting the PDCCH.

Here, the channel state may be defined by parameters such as:
Doppler shift
Doppler spread
Average delay
Delay spread
Spatial Rx parameter

Such a parameter may also be used to define the QCL type. Specifically, the QCL type is defined in Section 5.1.5 of 3GPP T538.214 as follows:
QCL-Type A: {Doppler shift, Doppler spread, average delay, delay spread}
QCL-Type B: {Doppler shift, Doppler spread}
QCL-Type C: {Doppler shift, average delay}
QCL-Type D: {Spatial Rx parameter}

Type A is always set as the TCI state of the DMRS of PDCCH/PDSCH, and in addition, Type D may be set (especially in the case of FR2).

Type A RS(CSI (Channel State Information)-RS) is used for long-term channel information measurement, and may be utilized for channel estimation of DMRS, for example. Since only instantaneous measurements can be obtained by measuring DMRS, Doppler information and the like cannot be obtained. The UE200 obtains QCL-Type A (Doppler shift, Doppler spread, average delay, delay spread) information by measuring periodic RS (For example, TRS (Tracking Reference Signal)) set as QCL Type A RS in advance, and receives PDSCH/PDCCH using these information.

Type D RS is used to notify the base station side transmission spatial domain filter (in short, analog beam). The UE200 selects an appropriate UE-side reception spatial domain filter by measuring the RS (For example, TRS) previously set as Type D RS, and receives PDCCH/PDSCH using the reception spatial domain filter when receiving PDCCH/PDSCH.

The TCI state of PDCCH may be notified by the RRC and/or MAC CE. The TCI state of PDSCH may be notified by up to eight RRC/MAC CEs and indicated by a TCI state field of up to three bits in DCI format 1_1/1_2 (present if the tciPresentInDCI of RRC is set).

If the time between DCI and PDSCH is less than timeDurationForQCL (described in detail below), the TCI state of PDSCH may be determined by a predetermined method. If DCI format 1_1/1_2 and tciPresentInDCI is not set, the TCI state of PDSCH may be determined by a predetermined method because there is no TCI state field.

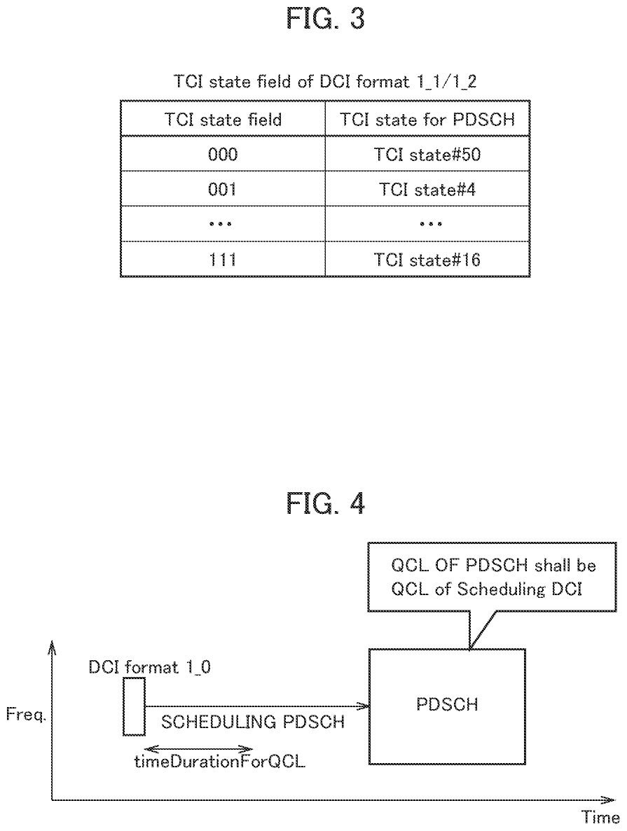

FIG. 3 shows an example of configuring the TCI state field of DCI format 1_1/1_2. As shown in FIG. 3, a 3-bit TCI state field may be assigned. The value of the TCI state field may be associated with the TCI state for a given PDSCH.

In DCI format 1_0, since there is no TCI state field in the first place, the TCI state of the PDSCH may be determined by a given method. Such a given method may be called the Default TCI state.

It is particularly expected that multicast PDSCH (MBS PDSCH) schedules use DCI format 1_0.

FIG. 4 shows an example of the relationship between DCI format 1_0, timeDurationForQCL, and PDSCH (unit 1). As shown in FIG. 4, PDSCH may be scheduled according to DCI format 1_0. Typically, the time between DCI and PDSCH is set longer than timeDurationForQCL.

If PDSCH is scheduled according to DCI format 1_0, it does not have a TCI state field, as described above. In this case, the time between DCI and PDSCH may be set longer than timeDurationForQCL.

In addition, the QCL of PDCCH (DCI) that scheduled PDSCH may be assumed to be the QCL of PDSCH.

### (1.3) Provision of MBS

In the radio communication system 10, multicast and broadcast services (MBS) may be provided.

For example, in a stadium or a hall, a large number of UE200s may be located in a certain geographical area, and a large number of UE200s receive the same data at the same time. In such a case, the use of MBS rather than unicast is effective.

Unicast may be interpreted as communication that takes place one-to-one with the network by specifying one specific UE200 (identification information specific to the UE200 may be specified).

Multicasting may be interpreted as communication that takes place one-to-many (specific many) with the network by specifying multiple specific UE200s (identification information for multicasting may be specified). It should be noted that as a result, the number of UE200s that receive data for receiving multicasting may be 1.

Broadcast may be interpreted as communication between the network and an unspecified number of UE200s. The data to be multicasted/broadcast may have identical copied content, but some content such as headers may be different. Also, while the data to be multicasted/broadcast may be transmitted (distributed) at the same time, it does not necessarily require strict concurrency and may include propagation delays and/or processing delays within RAN nodes, etc.

Note that the target UE200 may be in the radio resource control layer (RRC) state of either idle (RRC idle), connected (RRC connected) or other state (For example, an inactive state). The inactive state may be interpreted as a state in which some configurations of the RRC are maintained.

MBS envisions three methods for scheduling the multicast/broadcast Physical Downlink Shared Channel (PDSCH), specifically scheduling MBS packets (which may be read as data). RRC connected UE may be read as RRC idle UE and RRC inactive UE.
PTM transmission method 1 (PTM-1):—Schedule group-common PDSCH using group-common PDCCH (Physical Downlink Control Channel) for MBS group of RRC connected UE.
CRC(Cyclic Redundancy Checksum) and PDSCH of PDCCH are scrambled by group-common RNTI (Radio Network Temporary Identifier, may be called G-RNTI).
PTM Transmission Method 2 (PTM-2):—For the MBS group of the RRC connected UE, the group-common PDSCH is scheduled using the terminal-specific (UE-specific) PDCCH.
The CRC of the PDCCH is scrambled by the UE-specific RNTI.
The PDSCH is scrambled by the group-common RNTI.
PTP transmission method:—UE-specific PDSCH is scheduled for the RRC connected UE using UE-specific PDCCH.
CRC and PDSCH of PDCCH are scrambled by UE-specific RNTI. This may mean that MBS packets are transmitted by Unicast.

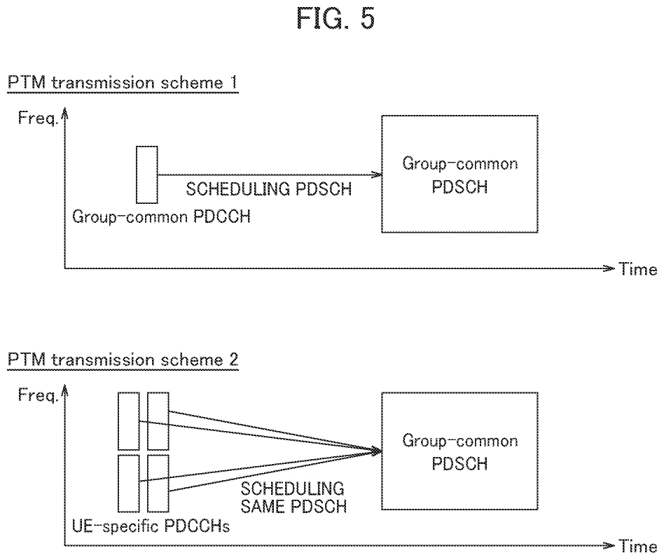

FIG. 5 shows a configuration example of PTM transmission method 1 and PTM transmission method 2. The UE-specific PDCCH/PDSCH may be identified by the target UE, but may not be identified by other UEs in the same MBS group. The group-common PDCCH/PDSCH is transmitted at the same time/frequency resource and can be identified by all UEs in the same MBS group. The names of the PTM transmission methods 1 and 2 are tentative names, and may be called by different names as long as the operations described above are executed.

In point-to-point (PTP) distribution, the RAN node may distribute individual copies of the MBS data packets by radio to individual UEs. In point-to-multipoint (PTM) distribution, the RAN node may distribute a single copy of the MBS data packets to a set of UEs by radio.

In order to improve the reliability of MBS, the following two feedback methods are envisaged for HARQ (Hybrid Automatic repeat request) feedback, specifically HARQ feedback for multicast/broadcast PDSCH.
Option 1: Feedback both ACK and NACK (ACK/NACK feedback)—The UE that successfully receives and decrypts the PDSCH sends an ACK—The UE that fails to receive and decrypt the PDSCH sends a NACK-PUCCH (Physical Uplink Control Channel) resource configurations: PUCCH-Config can be configured for multicasting
PUCCH resources: Shared/orthogonal between UEs depends on network configurations
HARQ-ACK CB (codebook): supports type-1 and type-2 (CB decision algorithm (specified in 3GPP TS 38.213) Multiplexing: Unicast or multicast can be applied
Option 2: NACK-only feedback
   A UE that successfully receives and decrypts a PDSCH does not send an ACK (does not send a response)
   UE that fails to receive and decrypt a PDSCH sends a NACK
   For a given UE, PUCCH resource configurations can be set separately by unicasting or group casting (multicast)

Note that ACK may be referred to as positive acknowledgement and NACK as negative acknowledgement. HARQ may be called an automatic retransmitting request.

Enabling/Disabling Option 1 or Option 2 may be either:
RRC and Downlink Control Information (DCI)
RRC only

In addition, the following is expected for semi-persistent scheduling (SPS) for multicast/broadcast PDSCH:
Adopts SPS group-common PDSCH
Multiple SPS group-common PDSCH can be configured for UE capability
HARQ feedback for SPS group-common PDSCH is possible
Activation/deactivation with at least group-common PDCCH is possible

Note that deactivation may be replaced with other synonymous terms such as release. For example, activation may be replaced with start, start, trigger, etc., and deactivation may be replaced with end, stop, etc.

SPS is scheduling used as a contrast to dynamic scheduling and may be referred to as semi-fixed, semi-persistent, semi-persistent, etc., and may be interpreted as Configured Scheduling (CS).

Scheduling may be interpreted as the process of allocating resources to transmit data. Dynamic scheduling may be interpreted as the mechanism by which all PDSCH are scheduled by DCI (For example, DCI 1_0, DCI 1_1, or DCI 1_2). SPS may be interpreted as the mechanism by which PDSCH transmissions are scheduled by higher layer signaling, such as RRC messages.

Also, regarding the physical layer, there may be a scheduling category of time domain scheduling and frequency domain scheduling.

Also, multicast, group cast, broadcast, and MBS may be interchanged. Multicast PDSCH (May include group-common PDSCH and SPS group-common PDSCH) and PDSCH scrambled by group common RNTI (may be called G-RNTI) may be interchanged.

In addition, data and packet terms may be interchanged and may be interpreted as synonymous with terms such as signal, data unit, etc. and transmission, reception, transmission and delivery may be interchanged.

### (2) Function Block Configuration of Radio Communication System

Next, a functional block configuration of radio communication system 10 will be described. Specifically, the functional block configuration of the gNB100 and the UE200 will be described.

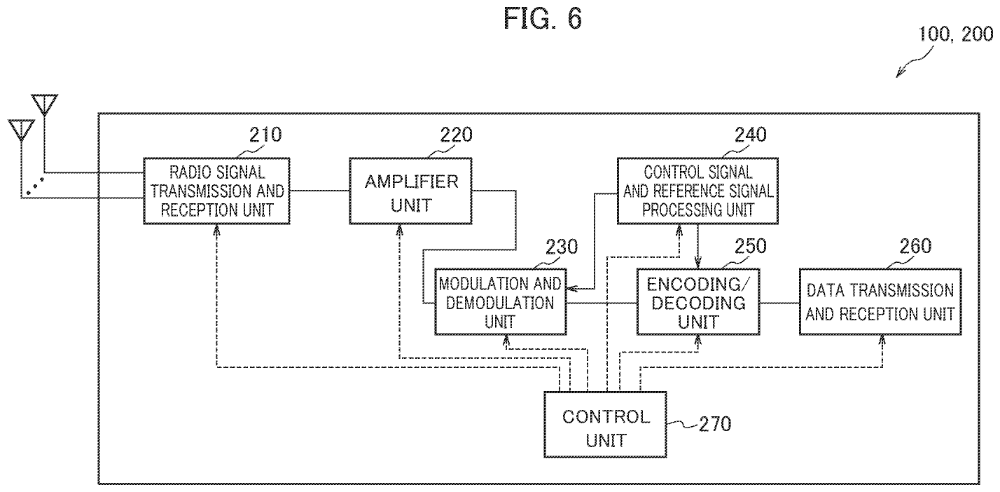

FIG. 6 is a functional block configuration diagram of the gNB100 and the UE200. The UE200 will be described below. As shown in FIG. 6, the UE200 includes a radio signal transmission and reception unit 210, an amplifier unit 220, a modulation and demodulation unit 230, a control signal and reference signal processing unit 240, an encoding/decoding unit 250, a data transmission and reception unit 260, and a control unit 270.

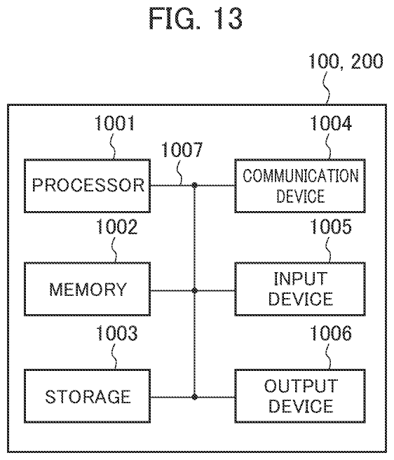

Note that in FIG. 6, only the main functional blocks related to the description of the embodiment are shown, and the UE200 includes other functional blocks (For example, the power supply unit). FIG. 4 also shows the functional block configuration of the UE200 (gNB100), and refer to FIG. 13 for the hardware configuration.

The radio signal transmission and reception unit 210 transmits and receives radio signals in accordance with the NR. The radio signal transmission and reception unit 210 supports Massive MIMO, CA using a plurality of CCs bundled together, DC communicating simultaneously between the UE and each of the two NG-RAN Nodes, and the like.

The radio signal transmission and reception unit 210 also supports MBS and can receive a downlink channel common to a group of terminals in data distribution for the plurality of UE200. In this embodiment, the radio signal transmission and reception unit 210 may comprise a reception unit that receives the downlink channel.

The radio signal transmission and reception unit 210 may receive the downlink data channel (PDSCH) common to the terminal group, specifically, the group-common PDSCH (which may include the SPS group-common PDSCH). The radio signal transmission and reception unit 210 may also receive the downlink control channel common to the terminal group, specifically, the group-common PDCCH.

The amplifier unit 220 is configured by a PA (Power Amplifier)/LNA (Low Noise Amplifier) or the like. The amplifier unit 220 amplifies the signal output from modulation and demodulation unit 230 to a predetermined power level. The amplifier unit 220 amplifies the RF signal output from radio signal transmission and reception unit 210.

The modulation and demodulation unit 230 performs data modulation/demodulation, transmission power setting, resource block allocation, etc. for each predetermined communication destination (gNB100, etc.). Cyclic Prefix-Orthogonal Frequency Division Multiplexing (CP-OFDM)/Discrete Fourier Transform-Spread (DFT-S-OFDM) may be applied to the modulation and demodulation unit 230. DFT-S-OFDM may be used not only for the uplink (UL) but also for the downlink (DL).

The control signal and reference signal processing unit 240 performs processing related to various control signals transmitted and received by the UE200 and various reference signals transmitted and received by the UE200.

Specifically, the control signal and reference signal processing unit 240 receives various control signals transmitted from the gNB100 via a predetermined control channel, for example, a radio resource control layer (RRC) control signal. The control signal and reference signal processing unit 240 also transmits various control signals to the gNB100 via a predetermined control channel.

The control signal and reference signal processing unit 240 performs processing using a reference signal (RS) such as a demodulation reference signal (DMRS) and a phase tracking reference signal (PTRS).

The DMRS is a known reference signal (pilot signal) between a base station and a terminal of each terminal for estimating a fading channel used for data demodulation. The PTRS is a reference signal of each terminal for estimating phase noise, which is a problem in a high frequency band.

In addition to the DMRS and the PTRS, the reference signal may include a Channel State Information-Reference Signal (CSI-RS), a Sounding Reference Signal (SRS), and a Positioning Reference Signal (PRS) for position information.

The channel may include a control channel and a data channel. The control channel may include PDCCH, PUCCH (Physical Uplink Control Channel), RACH (Random Access Channel, Downlink Control Information (DCI) with Random Access Radio Network Temporary Identifier (RA-RNTI)), and Physical Broadcast Channel (PBCH).

The data channels include PDSCH and PUSCH (Physical Uplink Shared Channel). Data may mean data transmitted over a data channel.

The control signal and reference signal processing unit 240 may receive higher layer (For example, RRC) control information including the QCL of the PDSCH. In this embodiment, the control signal and reference signal processing unit 240 may constitute a reception unit for receiving higher layer control information.

The encoding/decoding unit 250 performs data division/concatenation and channel coding/decoding for each predetermined communication destination (gNB100 or other gNB).

Specifically, the encoding/decoding unit 250 divides the data output from the data transmission and reception unit 260 into predetermined sizes and performs channel coding for the divided data. The encoding/decoding unit 250 decodes the data output from the modulation and demodulation unit 230 and concatenates the decoded data.

The data transmission and reception unit 260 transmits and receives the protocol data unit (PDU) and the service data unit (SDU). Specifically, the data transmission and reception unit 260 performs assembly/disassembly of the PDU/SDU in a plurality of layers (Media access control layer (MAC), radio link control layer (RLC), packet data convergence protocol layer (PDCP), etc.). The data transmission and reception unit 260 also performs data error correction and retransmission control based on the hybrid automatic repeat request (ARQ).

The control unit 270 controls each function block constituting the UE200. In particular, in the present embodiment, the control unit 270 performs control on the scheduling of the downlink channel with respect to the MBS and the HARQ feedback of the channel.

The control unit 270 performs control corresponding to the scheduling of the downlink data channel common to the terminal group (group common) in the data distribution for the MBS, that is, the plurality of UE200s. Specifically, the control unit 270 can perform control corresponding to scheduling of group-common PDCCH and group-common PDSCH.

The control unit 270 may assume that the QCL of PDSCH (May include group-common PDSCH and SPS group-common PDSCH) is in a specific state common to a plurality of UE200s when a specific condition is satisfied.

The specific condition may be, for example, any of the following:
The scheduling offset between DCI (PDCCH) and PDSCH is less than or equal to a predetermined time (For example, timeDurationForQCL).

Regardless of whether the scheduling offset is less than or equal to a predetermined time, the QCL of MBS PDSCH may be applied in the same manner, that is, it may be a specific state common to a plurality of UE200s.
A specific DCI format or DCI.

For example, DCI format 1_0 without TCI state field or DCI format 1_1, 1_2 without tciPresentInDCI.
When set by a higher layer (For example, RRC).
When reporting related UE capability information.

A specific state (which may be referred to as a predetermined QCL) common to multiple UE200s may be the QCL of the monitoring symbol of the PDCCH. That is, control unit 270 may receive the PDSCH based on the QCL of the PDCCH.

A QCL of a symbol other than the monitoring symbol of PDCCH may also be used. In this case, the control unit 270 may be based on a QCL of some received signal (channel), such as a QCL for unicast transmission or a QCL for multicast transmission, on which QCL the PDSCH is received may be set by the higher layer.

Alternatively, the control unit 270 may assume that the QCL of the PDSCH is in the same state as the QCL of the control resource set (CORESET). That is, the predetermined QCL may be the QCL of CORESET. The CORESET may be any CORESET associated with the MBS in the active BWP of the serving cell.

Alternatively, the control unit 270 may assume that the QCL of the PDSCH is in the same state as the QCL of the PDSCH and another PDSCH. Specifically, the control unit 270 may assume that the QCL of MBS PDSCH is the same as the QCL of another PDSCH related to MBS. For example, among the QCL of the MBS PDSCH, it may be the QCL of the smallest or largest DCI codepoint (which may be the TCI codepoint) or the QCL of the smallest or largest TCI state.

The control unit 270 may also determine the state of the QCL of the PDSCH based on the control information of the higher layer. Specifically, the control unit 270 may determine the state of the QCL of the PDSCH based on the information of the QCL contained in the control information of the higher layer (For example, RRC) received by the control signal and reference signal processing unit 240. Note that the control information is not limited to the RRC and may be notified by, for example, the MAC CE.

In addition, the gNB100 can perform the above-mentioned control of downlink channel scheduling and the like. Specifically, the radio signal transmission and reception unit 210 of the gNB100 may transmit the PDSCH common to the terminal group to a plurality of UE200s included in the terminal group in the MBS. The radio signal transmission and reception unit 210 of the gNB100 may constitute a transmission unit.

### (3) Operation of Radio Communication System

Next, the operation of radio communication system 10 will be described. Specifically, the operation related to the scheduling of the downlink channel with respect to the MBS, especially the assumption of the QCL, will be described.

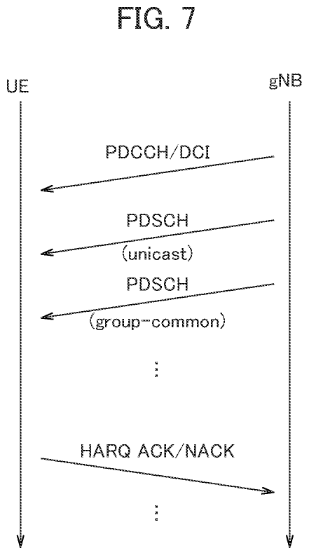

FIG. 7 shows an example sequence of PDCCH, PDSCH and HARQ feedback in the MBS. As shown in FIG. 7, PDCCH (which may include DCI) and PDSCH may be transmitted by unicast or multicast (broadcast). The UE200 may also transmit HARQ feedback (ACK/NACK) for the channel (transport block (TB) received via).

In FIG. 7, it appears that after one PDCCH/DCI, both unicast PDSCH and multicast PDSCH are transmitted, but after one PDCCH/DCI, either unicast PDSCH or multicast PDSCH may be transmitted. That is, one PDCCH/DCI may schedule either unicast PDSCH or multicast PDSCH.

With respect to the QCL, timeDurationForQCL is set as described above (see FIG. 4). timeDurationForQCL has a minimum of 14 symbols when SCS=120 kHz. On the other hand, in the case of MBS PDSCH, the constraint of always providing a scheduling offset between DCI and PDSCH of more than 14 symbols is considered undesirable.

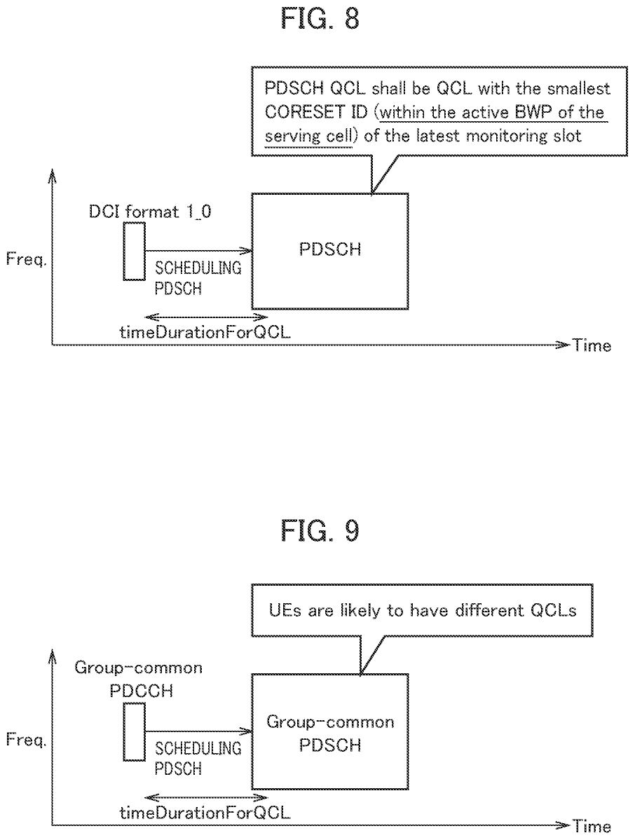

FIG. 8 shows an example (No. 2) of the relationship between DCI format 1_0, timeDurationForQCL and PDSCH. FIG. 8 shows an example in which the scheduling offset between DCI and PDSCH is shorter than timeDurationForQCL.

As described above, if PDSCH is scheduled in a time when the scheduling offset between DCI and PDSCH is shorter than timeDurationForQCL, UE200 receives PDSCH using the “QCL with the lowest CORESET ID of the most recent monitoring slot.”

Specifically, the UE may assume that the DM-RS ports of PDSCH of a serving cell are quasi co-located with the RS(s) with respect to the QCL parameter(s) used for PDCCH quasi co-location indication of the CORESET associated with a monitored search space with the lowest controlResourceSetId in the latest slot in which one or more CORESETs within the active BWP of the serving cell are monitored by the UE).

The “QCL of the least CORESET ID in the most recent monitoring slot” may vary from UE to UE. There is also the possibility of CORESET for unicast transmission. Therefore, it is highly likely that such an operation will not result in an appropriate QCL even if it is applied directly to MBS PDSCH.

Note that the UE cannot recognize the PDSCH schedule before the DCI decoding is completed. On the other hand, the DCI can schedule the PDSCH without a symbol gap. After receiving the search space, the UE executes the BD of the PDSCH and simultaneously stores (buffers) the DL received signal. After detecting the DCI, the UE demodulates and decodes the PDSCH using the stored DL signal when it is found that there is a PDSCH schedule on a symbol.

In 3GPP Releases-15 and 16, only one receiving beam can receive DL signals at a time. Therefore, when storing DL signals, it is necessary to receive them based on some kind of QCL. Thus, for example, 3GPP Release-15 specifies that when DCI to PDSCH is scheduled for a period shorter than timeDurationForQCL, PDSCH will be received using the “QCL with the lowest CORESET ID of the latest monitoring slot.”

FIG. 9 shows an example of the relationship between group-common PDCCH, timeDurationForQCL, and group-common PDSCH.

In the MBS, in a UE group (terminal group) using a certain G-RNTI, the same PDSCH cannot be received by the same QCL because the “QCL with the minimum CORESET ID of the latest monitoring slot” is different for each UE as described above.

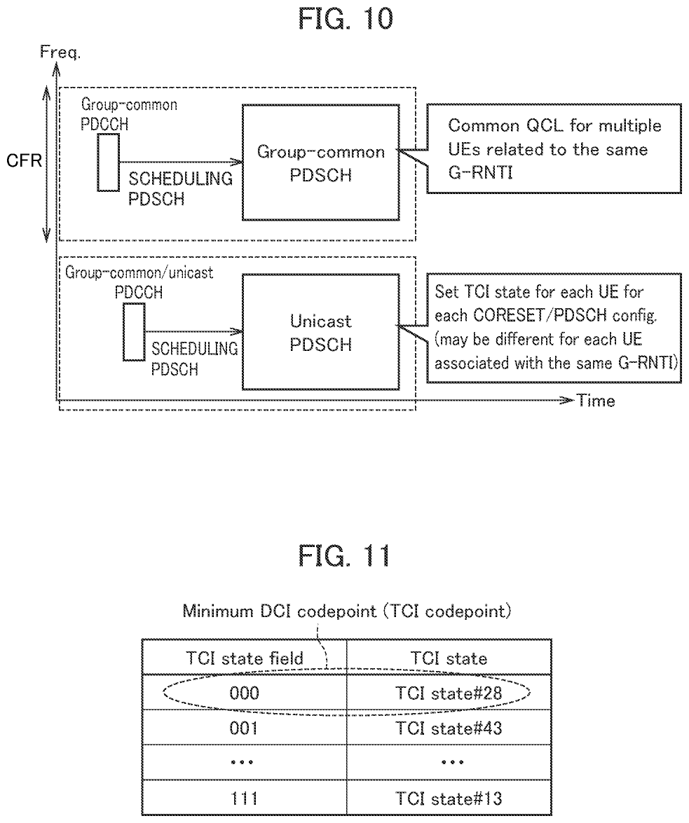

In addition, in the 3GPP, the configuration of the CFR (Common Frequency Resource, tentative name) is being considered for the MBS. FIG. 10 shows an example of the relationship between CFR, group-common PDCCH, group-common PDSCH and unicast PDCCH/PDSCH.

For example, defining CFR as MBS specific BWP (Option 2A) is being considered. With this option, since unicast and multicast are different BWPs, the QCL of the MBS PDSCH will be the QCL of the MBS PDCCH even as the QCL of the “QCL with the lowest CORESET ID of the latest monitoring slot” (in the active BWP of the serving cell). FIG. 10 shows an example in which the CFR is different from the BWP for unicast, but the configuration may be such that they are mutually inclusive.

On the other hand, defining the MBS frequency region in the dedicated unicast BWP (Option 2B) is also being considered. In this option, unicast and multicast become the same BWP, so if “QCL with the minimum CORESET ID of the latest monitoring slot” (in the active BWP of the serving cell) is assumed, the QCL of MBS PDSCH may become the QCL of unicast PDCCH, which is problematic.

In light of this situation, in the following operation example, the QCL of group-common PDSCH is common among UEs. The QCL of unicast PDCCH/PDSCH may be different between UEs. In addition,

Default TCI state (DCI to PDSCH is less than timeDurationForQCL) of group-common PDSCH is specified.

### (3.0) Example 0

In this example, a condition for applying a predetermined QCL to the MBS PDSCH is shown. The QCL of the PDSCH (DMRS of) associated with the MBS may be a predetermined QCL under a predetermined condition.

The predetermined condition may be any of the following:
The scheduling offset of DCI to PDSCH is a predetermined time (For example, less than (or equal to) timeDurationForQCL).

The QCL of MBS PDSCH may be applied in the same manner, not limited to a predetermined time or less.
Prescribed DCI format or DCI

Examples include a DCI format or DCI (For example, if tciPresentInDCI is not set in DCI format 1_0 or DCI format 1_1/1_2) that does not have a TCI state field.
Set by higher layer

For example, UE200 is configured by IE (enableDefaultTCIStateForMulticast) in RRC. enableDefaultTCIStateForMulticast may be interpreted as IE enabling the default TCI state for multicast.

You have Reported (Signaled) the Related UE Capability Information.

The PDSCH related to the MBS may be interpreted as a PDSCH-Config or PDSCHresource in which the MBS is set, or a PDSCH scheduled in CORESET/Search-Space (SS) related to the MBS. It may also be interpreted as a PDSCH scheduled in DCI with CRC scrambled by G-RNTI.

“MBS related” may be interpreted as “MBS frequency region (which may be CFR) related.”

“predetermined QCL” may be interpreted as a PDCCH monitoring symbol. In this case, the UE200 may receive a PDSCH based on the QCL of the PDCCH.

Alternatively, the predetermined QCL may be interpreted as a symbol other than the PDCCH monitoring symbol. In this case, the UE200 may store the received signal based on some predetermined QCL. Since the UE200 can assume only one predetermined QCL at a time, the higher layer may switch between applying a predetermined QCL for unicast or a predetermined QCL for multicast.

If enableDefaultTCIStateForMulticast is not configured, the UE200 may perform operations in accordance with 3GPP Release-15, specifically using the Type A RS or Type D RS described above, store the received signal assuming a predetermined QCL for unicast, and receive the PDSCH.

If enableDefaultTCIStateForMulticast is configured, the UE200 may perform operations in accordance with any of the operational examples described below, store the received signal assuming a predetermined QCL for multicast, and receive the PDSCH (which may be interpreted as operations in accordance with 3GPP Release-17).

enableDefaultTCIStateForMulticast is a working name, as described above, and may be referred to by another name.

### (3.1) Example 1

In this example, the “predetermined QCL” may be the QCL of CORESET. As described above, the PDSCH associated with the MBS may be received using the predetermined QCL.

The predetermined QCL may be the QCL of any of the following CORESETs associated with the MBS (However, in the active BWP of the serving cell):
The QCL with the minimum or maximum CORESET ID among the CORESETs associated with the MBS
The QCL with the minimum CORESET ID of the latest monitoring slot among the CORESETs associated with the MBS

According to this operation example, the same QCL as any CORESET from among the MBS CORESETs can be appropriately applied to the MBS PDSCH.

In the specification (For example, 3GPP TS38.214 5.1.5) of the 3GPP related to this operation example, it may be expressed as follows.

If a UE is configured with enableDefaultTCIStateForMulticast and the UE is configured by higher layer parameter PDCCH-Config that associates with MBS frequency region (CFR), the UE may assume that the DM-RS ports of PDSCH associated with MBS frequency region (CFR) of a serving cell are quasi co-located with the RS(s) with respect to the QCL parameter(s) used for PDCCH quasi co-location indication of the CORESET associated with a monitored search space with the lowest controlResourceSetId among CORESETs associated with MBS frequency region (CFR) in the latest monitoring slot within the active BWP of the serving cell.

### (3.2) Example 2

In this example, the “predetermined QCL” may be the QCL of the PDSCH. As described above, the PDSCH (DMRS) associated with the MBS may be received using the predetermined QCL.

The predetermined QCL may be any of the following QCLs of the PDSCH associated with the MBS:
Minimum or maximum DCI codepoint (or TCI codepoint) QCL
Minimum or maximum TCI state ID QCL

FIG. 11 shows an example of the minimum DCI codepoint according to operation example 2. As shown in FIG. 11, the minimum DCI codepoint (TCI state “*28” and the corresponding QCL for TCI state field “000”) may be selected.

According to this working example, a QCL properly configured for the MBS PDSCH can be applied to the MBS PDSCH.

In addition, the 3GPP specification (For example, 3GPP TS38.214 5.1.5) related to this working example may be expressed as follows.

If a UE is configured with enableDefaultTCIStateForMulticast and the UE is configured by higher layer parameter PDCCH-Config that associates with MBS frequency region (CFR), the UE may assume that the DM-RS ports of PDSCH associated with MBS frequency region (CFR) of a serving cell are quasi co-located with the RS(s) with respect to the QCL parameter(s) associated with the TCI states corresponding to the lowest codepoint among the TCI codepoints within PDSCH configured for MBS frequency region (CFR) within the active BWP of the serving cell.

### (3.3) Example 3

In this example, the “predetermined QCL” may be configured by the higher layer. As described above, the PDSCH associated with the MBS may be received using the predetermined QCL.

The predetermined QCL set by the higher layer may be the TCI state or QCL set by the RRC or MAC CE.

In this case, the TCI state/QCL used in the Default TCI state may be previously set by the higher layer. The TCI state/QCL may be called Unified TCI, Common TCI state/QCL, or the like. In particular, the TCI state/QCL configured in relation to the MBS may be used.

According to this operation example, a QCL appropriately configured for the MBS may be applied to the MBS PDSCH.

In addition, the 3GPP specification (For example, 3GPP TS38.214 5.1.5) related to this operation example may be expressed as follows.

If a UE is configured with enableDefaultTCIStateForMulticast and the UE is configured by higher layer parameter PDCCH-Config that associates with MBS frequency region (CFR), the UE may assume that the DM-RS ports of PDSCH associated with MBS frequency region (CFR) of a serving cell are quasi co-located with the RS(s) with respect to the QCL parameter(s) associated with the TCI states configured for MBS frequency region (CFR) within the active BWP of the serving cell.

### (3.4) Modifications

In the above operation example, the following modifications may be made. For example, in the proposed representation of the 3GPP specification for operation example 1-3, it was stated that when enableDefaultTCIStateForMulticast is set, PDSCH related to MBS is received based on the predetermined QCL for MBS.

In this case, the Default TCI state (That is, for unicast DCI to unicast PDSCH<timeDurationForQCL, a QCL for Unicast PDSCH scheduled by a DCI (For example, DCI format 1_0 without TCI state field, or DCI format 1_1, 1_2 without tciPresentInDCI) that does not have a TCI state field) of unicast PDSCH is not clear.

Therefore, gNB100 and UE200 may operate by any of the following.
For the Default TCI state of the unicast PDSCH, the operation using Type A RS or Type D RS described above, specifically, the operation for measuring Type A RS or Type D RS described in (1.2) QCL/TCI state, is executed, and for the Default TCI state of the multicast PDSCH, the operation example described above is followed.
For the Default TCI state of the unicast PDSCH, the operation example is followed similarly to the Default TCI state of the multicast PDSCH (but only if enableDefaultTCIStateForMulticast is configured).

The UE200 may receive a multicast/unicast PDSCH on a given QCL under a given condition when enableDefaultTCIStateForMulticast is set.

In light of this behavior, the proposed wording of the 3GPP specification described above stated “The UE assumes that the DM-RS port on the PDSCH associated with the MBS frequency domain (CFR) of the serving cell is . . . ” (The UE may assume that the DM-RS ports of PDSCH associated with MBS frequency region (CFR) . . . ), but the portion of “associated CFR with MBS frequency region (CFR) of the serving cell” may be deleted.

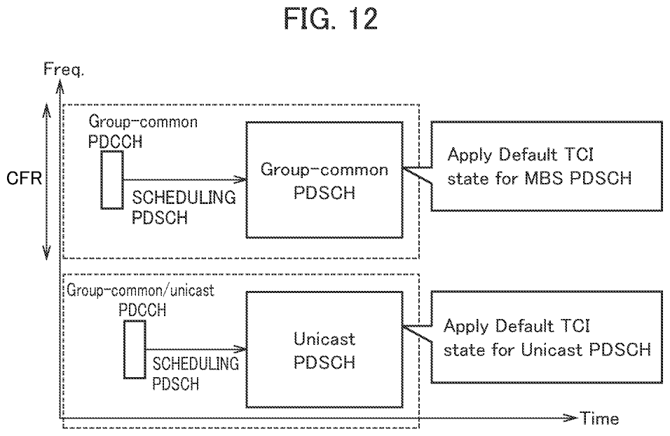

FIG. 12 shows an example of the relationship between CFR, group-common PDCCH, group-common PDSCH, and unicast PDCCH/PDSCH related to the modified example.

As shown in FIG. 12, when the schedule resource of PDSCH is related to MBS CFR (included in CFR), the Default TCI state for MBS PDSCH may be applied.

On the other hand, when CORESET/SS/CCE (control channel element) is related to MBS CFR (included in CFR), the Default TCI state for MBS PDSCH may be applied for PDSCH scheduled by the DCI.

### (4) Operational Effects

According to the above-described embodiment, the following effects can be obtained. Specifically, according to the gNB100 and the UE200 according to the operation example 0-3, an appropriate quasi collocation (QCL) can be assumed in the MBS, that is, a simultaneous data transmission service to a plurality of specified or unspecified UEs.

In particular, an appropriate quasi collocation (QCL) in the MBS can be assumed even if the PDSCH is scheduled in a time when the scheduling offset between DCI and PDSCH is shorter than timeDurationForQCL.

### (5) Other Embodiments

Although the embodiments have been described above, they are not limited to the description of the embodiments, and it is obvious to those skilled in the art that various modifications and improvements can be made.

For example, in the embodiments described above, the names PDCCH and PDSCH were used as the downlink channels, but the downlink control channels or downlink data channels (which may be shared channels) may be called by different names.

In the above-described embodiment, the MBS PDSCH has been described as an example, but at least any of the above-described operation examples may also be applied to other downlink channels such as the MBS PDCCH. Furthermore, the above-described operation examples may be combined and applied in combination as long as there is no conflict.

In the foregoing description, configure, activate, update, indicate, enable, specify, and select may be interchanged. Similarly, link, associate, correspond, and map may be interchanged, and allocate, assign, monitor, and map may be interchanged.

In addition, specific, dedicated, UE-specific, and UE-specific may be interchanged. Similarly, common, shared, group-common, UE-common, and UE-shared may be interchanged.

Further, the block configuration diagram (FIG. 6) used for the description of the above-described embodiment shows blocks of functional units. Those functional blocks (structural components) can be realized by a desired combination of at least one of hardware and software. Means for realizing each functional block is not particularly limited. That is, each functional block may be realized by one device combined physically or logically. Alternatively, two or more devices separated physically or logically may be directly or indirectly connected (for example, wired, or wireless) to each other, and each functional block may be realized by these plural devices. The functional blocks may be realized by combining software with the one device or the plural devices mentioned above.

Functions include judging, deciding, determining, calculating, computing, processing, deriving, investigating, searching, confirming, receiving, transmitting, outputting, accessing, resolving, selecting, choosing, establishing, comparing, assuming, expecting, considering, broadcasting, notifying, communicating, forwarding, configuring, reconfiguring, allocating (mapping), assigning, and the like. However, the functions are not limited thereto. For example, a functional block (configuration part) that functions transmission is called a transmission unit (transmitting unit) or a transmitter. As described above, the method of realization of both is not particularly limited.

Furthermore, the gNB100 and UE200 described above may function as computers for processing the radio communication method of the present disclosure. FIG. 13 is a diagram showing an example of a hardware configuration of the device. As shown in FIG. 13, the device may be configured as a computer device including a processor 1001, a memory 1002, a storage 1003, a communication device 1004, an input device 1005, an output device 1006 and a bus 1007.

Furthermore, in the following explanation, the term “device” can be replaced with a circuit, device, unit, and the like. Hardware configuration of the device can be constituted by including one or plurality of the devices shown in the figure, or can be constituted by without including a part of the devices.

Each functional block of the device (see FIG. 6) is implemented by any hardware element or combination of hardware elements of the computer device.

Moreover, the processor 1001 performs computing by loading a predetermined software (computer program) on hardware such as the processor 1001 and the memory 1002, and realizes various functions of the reference device by controlling communication via the communication device 1004, and controlling reading and/or writing of data on the memory 1002 and the storage 1003.

Processor 1001, for example, operates an operating system to control the entire computer. Processor 1001 may be configured with a central processing unit (CPU), including interfaces to peripheral devices, controls, computing devices, registers, etc.

Moreover, the processor 1001 reads a computer program (program code), a software module, data, and the like from the storage 1003 and/or the communication device 1004 into the memory 1002, and executes various processes according to the data. As the computer program, a computer program that is capable of executing on the computer at least a part of the operation explained in the above embodiments is used. Alternatively, various processes explained above can be executed by one processor 1001 or can be executed simultaneously or sequentially by two or more processors 1001. The processor 1001 can be implemented by using one or more chips. Alternatively, the computer program can be transmitted from a network via a telecommunication line.

The memory 1002 is a computer readable recording medium and is configured, for example, with at least one of Read Only Memory (ROM), Erasable Programmable ROM (EPROM), Electrically Erasable Programmable ROM (EEPROM), Random Access Memory (RAM), and the like. The memory 1002 may be referred to as a register, cache, main memory (main storage device), or the like. The memory 1002 may store a program (program code), a software module, or the like capable of executing a method according to an embodiment of the present disclosure.

The storage 1003 is a computer readable recording medium. Examples of the storage 1003 include an optical disk such as Compact Disc ROM (CD-ROM), a hard disk drive, a flexible disk, a magneto-optical disk (for example, a compact disk, a digital versatile disk, Blu-ray (Registered Trademark) disk), a smart card, a flash memory (for example, a card, a stick, a key drive), a floppy (Registered Trademark) disk, a magnetic strip, and the like. The storage 1003 can be called an auxiliary storage device. The recording medium can be, for example, a database including the memory 1002 and/or the storage 1003, a server, or other appropriate medium.

The communication device 1004 is hardware (transmission/reception device) capable of performing communication between computers via a wired and/or wireless network. The communication device 1004 is also called, for example, a network device, a network controller, a network card, a communication module, and the like.

The communication device 1004 includes a high-frequency switch, a duplexer, a filter, a frequency synthesizer, and the like in order to realize, for example, at least one of Frequency Division Duplex (FDD) and Time Division Duplex (TDD).

The input device 1005 is an input device (for example, a keyboard, a mouse, a microphone, a switch, a button, a sensor, and the like) that accepts input from the outside. The output device 1006 is an output device (for example, a display, a speaker, an LED lamp, and the like) that outputs data to the outside. Note that, the input device 1005 and the output device 1006 may be integrated (for example, a touch screen).

Each device, such as the processor 1001 and the memory 1002, is connected by a bus 1007 for communicating information. The bus 1007 may be configured using a single bus or a different bus for each device.

In addition, the device may be configured to include hardware such as a microprocessor, a digital signal processor (DSP), an application specific integrated circuit (ASIC), a programmable logic device (PLD), a field programmable gate array (FPGA), or the like, which may provide some or all of each functional block. For example, the processor 1001 may be implemented by using at least one of these hardware.

Further, the notification of information is not limited to the aspects/embodiments described in the present disclosure and may be carried out using other methods. For example, the notification of information may be performed by physical layer signaling (e.g., Downlink Control Information (DCI), Uplink Control Information (UCI), higher layer signaling (e.g., RRC signaling, Medium Access Control (MAC) signaling, Notification Information (Master Information Block (MIB), System Information Block (SIB)), other signals or combinations thereof. RRC signaling may also be referred to as RRC messages, e.g., RRC Connection Setup messages, RRC Connection Reconfiguration messages, etc.

Each of the above aspects/embodiments can be applied to at least one of Long Term Evolution (LTE), LTE-Advanced (LTE-A), SUPER 3G, IMT-Advanced, 4th generation mobile communication system (4G), 5th generation mobile communication system (5G), Future Radio Access (FRA), New Radio (NR), W-CDMA (Registered Trademark), GSM (Registered Trademark), CDMA2000, Ultra Mobile Broadband (UMB), IEEE 802.11 (Wi-Fi (Registered Trademark)), IEEE 802.16 (WiMAX (Registered Trademark)), IEEE 802.20, Ultra-WideBand (UWB), Bluetooth (Registered Trademark), a system using any other appropriate system, and a next-generation system that is expanded based on these. Further, a plurality of systems may be combined (for example, a combination of at least one of the LTE and the LTE-A with the 5G).

The processing steps, sequences, flowcharts, etc., of each of the embodiments/embodiments described in the present disclosure may be reordered as long as there is no conflict. For example, the method described in the present disclosure presents elements of various steps using an exemplary sequence and is not limited to the particular sequence presented.

The specific operation that is performed by the base station in the present disclosure may be performed by its upper node in some cases. In a network constituted by one or more network nodes having a base station, the various operations performed for communication with the terminal may be performed by at least one of the base station and other network nodes other than the base station (for example, MME, S-GW, and the like may be considered, but not limited thereto). In the above, an example in which there is one network node other than the base station is explained; however, a combination of a plurality of other network nodes (for example, MME and S-GW) may be used.

Information, signals (information and the like) can be output from a higher layer (or lower layer) to a lower layer (or higher layer). It may be input and output via a plurality of network nodes.

The input/output information can be stored in a specific location (for example, a memory) or can be managed in a management table. The information to be input/output can be overwritten, updated, or added. The information can be deleted after outputting. The inputted information can be transmitted to another device.

The determination may be made by a value (0 or 1) represented by one bit or by Boolean value (Boolean: true or false), or by comparison of numerical values (for example, comparison with a predetermined value).

Each of the embodiments/embodiments described in the present disclosure may be used alone, in combination, or alternatively with execution. In addition, notification of predetermined information (for example, notification of “being X”) is not limited to being performed explicitly, it may be performed implicitly (for example, without notifying the predetermined information).

Instead of being referred to as software, firmware, middleware, microcode, hardware description language, or some other name, software should be interpreted broadly to mean instruction, instruction set, code, code segment, program code, program, subprogram, software module, application, software application, software package, routine, subroutine, object, executable file, execution thread, procedure, function, and the like.

Further, software, instruction, information, and the like may be transmitted and received via a transmission medium. For example, when a software is transmitted from a website, a server, or some other remote source by using at least one of a wired technology (coaxial cable, fiber optic cable, twisted pair, Digital Subscriber Line (DSL), or the like) and a wireless technology (infrared light, microwave, or the like), then at least one of these wired and wireless technologies is included within the definition of the transmission medium.

Information, signals, or the like mentioned above may be represented by using any of a variety of different technologies. For example, data, instruction, command, information, signal, bit, symbol, chip, or the like that may be mentioned throughout the above description may be represented by voltage, current, electromagnetic wave, magnetic field or magnetic particle, optical field or photons, or a desired combination thereof.

It should be noted that the terms described in this disclosure and terms necessary for understanding the present disclosure may be replaced by terms having the same or similar meanings. For example, at least one of the channels and symbols may be a signal (signaling). The signal may also be a message. Also, a signal may be a message. Further, a component carrier (Component Carrier: CC) may be referred to as a carrier frequency, a cell, a frequency carrier, or the like.

The terms “system” and “network” used in the present disclosure can be used interchangeably.

Furthermore, the information, the parameter, and the like explained in the present disclosure can be represented by an absolute value, can be expressed as a relative value from a predetermined value, or can be represented by corresponding other information. For example, the radio resource can be indicated by an index.

The name used for the above parameter is not a restrictive name in any respect. In addition, formulas and the like using these parameters may be different from those explicitly disclosed in the present disclosure. Because the various channels (for example, PUCCH, PDCCH, or the like) and information element can be identified by any suitable name, the various names assigned to these various channels and information elements shall not be restricted in any way.

In the present disclosure, it is assumed that “base station (Base Station: BS),” “radio base station,” “fixed station,” “NodeB,” “eNodeB (eNB),” “gNodeB (gNB),” “access point,” “transmission point,” “reception point,” “transmission/reception point,” “cell,” “sector,” “cell group,” “carrier,” “component carrier,” and the like can be used interchangeably. The base station may also be referred to with the terms such as a macro cell, a small cell, a femtocell, or a pico cell.

The base station can accommodate one or more (for example, three) cells (also called sectors). In a configuration in which the base station accommodates a plurality of cells, the entire coverage area of the base station can be divided into a plurality of smaller areas. In each such a smaller area, communication service can be provided by a base station subsystem (for example, a small base station for indoor use (Remote Radio Head: RRH)).

The term “cell” or “sector” refers to a part or all of the coverage area of a base station and/or a base station subsystem that performs communication service in this coverage.

In the present disclosure, the terms “mobile station (Mobile Station: MS),” “user terminal,” “user equipment (User Equipment: UE),” “terminal” and the like can be used interchangeably.

The mobile station is called by the persons skilled in the art as a subscriber station, a mobile unit, a subscriber unit, a radio unit, a remote unit, a mobile device, a radio device, a radio communication device, a remote device, a mobile subscriber station, an access terminal, a mobile terminal, a radio terminal, a remote terminal, a handset, a user agent, a mobile client, a client, or with some other suitable term.

At least one of a base station and a mobile station may be called a transmitting device, a receiving device, a communication device, or the like. Note that, at least one of a base station and a mobile station may be a device mounted on a moving body, a moving body itself, or the like. The mobile may be a vehicle (For example, cars, planes, etc.), an unmanned mobile (For example, drones, self-driving cars), or a robot (manned or unmanned). At least one of a base station and a mobile station can be a device that does not necessarily move during the communication operation. For example, at least one of a base station and a mobile station may be an Internet of Things (IoT) device such as a sensor.

The base station in the present disclosure may be read as a mobile station (user terminal, hereinafter the same). For example, each aspect/embodiment of the present disclosure may be applied to a configuration in which communication between a base station and a mobile station is replaced by communication between a plurality of mobile stations (For example, it may be called device-to-device (D2D), vehicle-to-everything (V2X), etc.). In this case, the mobile station may have the function of the base station. Further, words such as “up” and “down” may be replaced with words corresponding to communication between terminals (For example, “side”). For example, up channels, down channels, etc. may be replaced with side channels (or side links).

Similarly, mobile stations in the present disclosure may be replaced with base stations. In this case, the base station may have the function of the mobile station. A radio frame may be composed of one or more frames in the time domain. Each frame or frames in the time domain may be referred to as a subframe. A subframe may be further configured by one or more slots in the time domain. Subframes may be of a fixed time length (For example, 1 ms) independent of numerology.

Numerology may be a communication parameter applied to at least one of transmission and reception of a certain signal or channel. The numerology can include one among, for example, subcarrier spacing (SubCarrier Spacing: SCS), bandwidth, symbol length, cyclic prefix length, transmission time interval (Transmission Time Interval: TTI), number of symbols per TTI, radio frame configuration, a specific filtering process performed by a transceiver in the frequency domain, a specific windowing process performed by a transceiver in the time domain, and the like.

The slot may be configured with one or a plurality of symbols (Orthogonal Frequency Division Multiplexing (OFDM)) symbols, Single Carrier Frequency Division Multiple Access (SC-FDMA) symbols, etc.) in the time domain. A slot may be a unit of time based on the numerology.

A slot may include a plurality of minislots. Each minislot may be configured with one or more symbols in the time domain. A minislot may also be called a subslot. A minislot may be composed of fewer symbols than slots. PDSCH (or PUSCH) transmitted in units of time greater than the minislot may be referred to as PDSCH (or PUSCH) mapping type A. PDSCH (or PUSCH) transmitted using a minislot may be referred to as PDSCH (or PUSCH) mapping type B.

Each of the radio frame, subframe, slot, minislot, and symbol represents a time unit for transmitting a signal. Different names may be used for the radio frame, subframe, slot, minislot, and symbol.

For example, one subframe may be called a transmission time interval (TTI), a plurality of consecutive subframes may be called TTI, and one slot or one minislot may be called TTI. That is, at least one of the subframes and TTI may be a subframe in an existing LTE (1 ms), a period shorter than 1 ms (For example, 1-13 symbols), or a period longer than 1 ms. Note that, a unit representing TTI may be called a slot, a minislot, or the like instead of a subframe.

Here, TTI refers to the minimum time unit of scheduling in radio communication, for example. Here, TTI refers to the minimum time unit of scheduling in radio communication, for example. For example, in the LTE system, the base station performs scheduling for allocating radio resources (frequency bandwidth, transmission power, etc. that can be used in each user terminal) to each user terminal in units of TTI. The definition of TTI is not limited to this.

The TTI may be a transmission time unit such as a channel-encoded data packet (transport block), a code block, or a code word, or may be a processing unit such as scheduling or link adaptation. When TTI is given, a time interval (for example, the number of symbols) in which a transport block, a code block, a code word, etc. are actually mapped may be shorter than TTI.

When one slot or one minislot is called TTI, one or more TTIs (that is, one or more slots or one or more minislots) may be the minimum scheduling unit. The number of slots (number of minislots) constituting the minimum time unit of the scheduling may be controlled.

TTI having a time length of 1 ms may be referred to as an ordinary TTI (TTI in LTE Rel. 8-12), a normal TTI, a long TTI, a normal subframe, a normal subframe, a long subframe, a slot, and the like. TTI shorter than the ordinary TTI may be referred to as a shortened TTI, a short TTI, a partial TTI (partial or fractional TTI), a shortened subframe, a short subframe, a minislot, a subslot, a slot, and the like.

In addition, a long TTI (for example, ordinary TTI, subframe, etc.) may be read as TTI having a time length exceeding 1 ms, and a short TTI (for example, shortened TTI) may be read as TTI having TTI length of less than the TTI length of the long TTI but TTI length of 1 ms or more.

The resource block (RB) is a resource allocation unit in the time domain and frequency domain, and may include one or a plurality of continuous subcarriers in the frequency domain. The number of subcarriers included in RB may be, for example, twelve, and the same regardless of the topology. The number of subcarriers included in the RB may be determined based on the neurology.

Also, the time domain of RB may include one or a plurality of symbols, and may have a length of 1 slot, 1 minislot, 1 subframe, or 1 TTI. Each TTI, subframe, etc. may be composed of one or more resource blocks.

Note that, one or more RBs may be called a physical resource block (Physical RB: PRB), a subcarrier group (Sub-Carrier Group: SCG), a resource element group (Resource Element Group: REG), PRB pair, RB pair, etc.

A resource block may be configured by one or a plurality of resource elements (Resource Element: RE). For example, one RE may be a radio resource area of one subcarrier and one symbol.

A bandwidth part (BWP) (which may be called a partial bandwidth, etc.) may represent a subset of contiguous common resource blocks (RBs) for a certain neurology in a certain carrier. Here, the common RB may be specified by an index of the RB relative to the common reference point of the carrier. PRB may be defined in BWP and numbered within that BWP.

BWP may include UL BWP (UL BWP) and DL BWP (DL BWP). One or a plurality of BWPs may be configured in one carrier for the UE.

At least one of the configured BWPs may be active, and the UE may not expect to send and receive certain signals/channels outside the active BWP. Note that “cell,” “carrier,” and the like in this disclosure may be read as “BWP.”

The above-described structures such as a radio frame, subframe, slot, minislot, and symbol are merely examples. For example, the number of subframes included in a radio frame, the number of slots per subframe or radio frame, the number of minislots included in a slot, the number of symbols and RBs included in a slot or minislot, the subcarriers included in RBs, and the number of symbols included in TTI, a symbol length, the cyclic prefix (CP) length, and the like can be changed in various manner.

The terms “connected,” “coupled,” or any variations thereof, mean any direct or indirect connection or coupling between two or more elements. Also, one or more intermediate elements may be present between two elements that are “connected” or “coupled” to each other. The coupling or connection between the elements may be physical, logical, or a combination thereof. For example, “connection” may be read as “access.” In the present disclosure, two elements can be “connected” or “coupled” to each other by using one or more wires, cables, printed electrical connections, and as some non-limiting and non-exhaustive examples, by using electromagnetic energy having wavelengths in the microwave region and light (both visible and invisible) regions, and the like.

The reference signal may be abbreviated as Reference Signal (RS) and may be called pilot (Pilot) according to applicable standards.

As used in the present disclosure, the phrase “based on” does not mean “based only on” unless explicitly stated otherwise. In other words, the phrase “based on” means both “based only on” and “based at least on.”

The “means” in the configuration of each apparatus may be replaced with “unit,” “circuit,” “device,” and the like.

Any reference to an element using a designation such as “first,” “second,” and the like used in the present disclosure generally does not limit the amount or order of those elements. Such designations can be used in the present disclosure as a convenient way to distinguish between two or more elements. Thus, the reference to the first and second elements does not imply that only two elements can be adopted, or that the first element must precede the second element in some or the other manner.

In the present disclosure, the used terms “include,” “including,” and variants thereof are intended to be inclusive in a manner similar to the term “comprising.” Furthermore, the term “or” used in the present disclosure is intended not to be an exclusive disjunction.

Throughout this disclosure, for example, during translation, if articles such as a, an, and the in English are added, in this disclosure, these articles shall include plurality of nouns following these articles.

As used in this disclosure, the terms “determining,” “judging” and “deciding” may encompass a wide variety of actions. “Judgment” and “decision” includes judging or deciding by, for example, judging, calculating, computing, processing, deriving, investigating, looking up, search, inquiry (e.g., searching in a table, database, or other data structure), ascertaining, and the like. In addition, “judgment” and “decision” can include judging or deciding by receiving (for example, receiving information), transmitting (for example, transmitting information), input (input), output (output), and access (accessing) (e.g., accessing data in a memory). In addition, “judgement” and “decision” can include judging or deciding by resolving, selecting, choosing, establishing, and comparing. In other words, “judgment” and “decision” may include regarding some action as “judgment” and “decision.” Moreover, “judgment (decision)” may be read as “assuming,” “expecting,” “considering,” and the like.

In the present disclosure, the term “A and B are different” may mean “A and B are different from each other.” It should be noted that the term may mean “A and B are each different from C.” Terms such as “leave,” “coupled,” or the like may also be interpreted in the same manner as “different.”

Although the present disclosure has been described in detail above, it will be obvious to those skilled in the art that the present disclosure is not limited to the embodiments described in this disclosure. The present disclosure can be implemented as modifications and variations without departing from the spirit and scope of the present disclosure as defined by the claims. Therefore, the description of the present disclosure is for the purpose of illustration, and does not have any restrictive meaning to the present disclosure.

### EXPLANATION OF REFERENCE NUMERALS

10 radio communication system
20 NG-RAN
100 gNB
200 UE
210 radio signal transmission and reception unit
220 amplifier unit
230 modulation and demodulation unit
240 control signal and reference signal processing unit
250 encoding/decoding unit
260 data transmission and reception unit
270 control unit
1001 processor
1002 memory
1003 storage
1004 communication device
1005 input device
1006 output device
1007 bus

1. A terminal comprising:
a reception unit that receives a downlink data channel common to a group of terminals in data distribution for a plurality of terminals; and
a control unit that assumes that quasi collocation of the downlink data channel is a specific state common to the plurality of terminals when a specific condition is satisfied.

2. The terminal according to claim 1, wherein the control unit assumes that the quasi collocation of the downlink data channel is in the same state as the quasi collocation of the control resource set.

3. The terminal according to claim 1, wherein the control unit assumes that the quasi collocation of the downlink data channel is in the same state as the quasi collocation of a downlink data channel that is different from the downlink data channel.

4. The terminal according to claim 1, wherein the reception unit receives control information of a higher layer including the quasi collocation of the downlink data channel, and
the control unit determines a state of the quasi collocation of the downlink data channel based on the control information.

5. A radio communication system including a radio base station and a terminal, wherein
the radio base station comprises a transmission unit that transmits a downlink data channel common to a group of terminals in data distribution for a plurality of terminals, and
the terminal comprises:
a reception unit that receives the downlink data channel; and
a control unit that assumes that quasi collocation of the downlink data channel is a specific state common to the plurality of terminals when a specific condition is satisfied.

6. A radio communication method comprising the steps of:
receiving a downlink data channel common to a group of terminals in data distribution for a plurality of terminals; and
assuming that quasi collocation of the downlink data channel is in a specific state common to the plurality of terminals when a specific condition is satisfied.
